(19) United States
(12) Patent Application Publication
(10) Pub. No.: US 2006/0096429 A1
(43) Pub. Date: May 11, 2006

(54) Water jet cutting device

(76) Inventors: Andreas Neumann, Ulm (DE); Rouven Hohage, Heidenheim (DE)

Correspondence Address: GREENBLUM & BERNSTEIN, P.L.C., 1950 ROLAND CLARKE PLACE, RESTON, VA, 20191, US

(21) Appl. No.: 10/542,414

(22) PCT Filed: Dec. 19, 2003
(86) PCT No.: PCT/EP03/51081

§ 371 Date: Oct. 6, 2005

(30) Foreign Application Priority Data
Jan. 18, 2003 (DE) 103 01 772.0

(51) Int. Cl. B26F 3/00

(52) U.S. Cl. 83/177; 83/53

(57) ABSTRACT

The invention relates to a water jet cutting device for cutting an advancing web (1) of paper, cardboard, tissue, or another fibrous material in a machine used for producing and/or finishing said web. The inventive water jet cutting device comprises at least two water jet nozzles (4, 5) that are disposed approximately behind each other in the direction of advancement (6) of the web and are directed on to the fiber web (1), the fiber web (1) resting on a rotating roller (3) or a continuously revolving belt (2) during the cutting process. The aim of the invention is to improve the quality of the cut while protecting the surface which supports the fiber web (1). Said aim is achieved by the fact that at least two water jet nozzles (4, 5) have different nozzle diameters and/or are placed at different distances from the fiber web (1) and/or are differently inclined relative to the surface of the fiber web (1).

The invention relates to a water jet cutting device for cutting a moving web of paper, board, tissue or other fibrous material in a machine for producing and/or finishing the same, comprising at least two water jet nozzles which are arranged approximately behind one another in the web running direction and are directed onto the fibrous web, the fibrous web, during the cutting operation, being supported on a rotating roller or on an endlessly rotating belt.

Water jet cutting devices of this type have long been known and are described, for example, in DE-U9103749.

The object in the above case was to reduce the loading of the supporting roll surface by the high water pressures from the water jets, which was also achieved by the use of two water jet nozzles with a lower water pressure. However, the lower water pressure also has an adverse effect on the quality of cut.

Therefore, the object of the invention is to improve the quality of cut while preserving the surface supporting the fibrous web.

According to the invention, the object was achieved by virtue of the fact that at least two water jet nozzles have nozzle diameters of different sizes and/or are at different distances from the fibrous web and/or have different inclinations with respect to the surface of the fibrous web.

Whereas the diameters of the water jets on striking the fibrous web can be influenced by the nozzle diameters and the distances from the fibrous web, by varying the inclinations it is possible to fix the action of the water jets on the cut.

Depending on the type, grammage and thickness of the fibrous web, it may, for example, be advantageous for the sprayed area of the water jet which strikes the fibrous web first to be larger than that of the following water jet, in order in this way also to soften the edge regions of the cut, so that the subsequent water jet can cut more easily and more accurately. This can advantageously be achieved by using different nozzle spray characteristics.

However, the strip which is softened by the first water jet must not be too wide, in order not to make the cut edges susceptible to tears or the like.

However, on the other hand it may also be advantageous for the fibrous web to be separated as far as possible with the aid of the first water jet with a small diameter and if appropriate also a relatively high water pressure, and then for the fibrous web, in order to protect the supporting surface, to be fully separated by a water jet with a larger diameter when it strikes the web and optionally a lower water pressure.

The inclination of the water jets may also be adapted to their specific function.

For example, at least one water jet, in particular the first water jet, may be inclined in the opposite direction to the web running direction, which improves the softening of the cut region. Moreover, this reduces the loading on the supporting surface, i.e. the roll or the belt, by the water jets, which is not inconsiderable on account of the high water pressures used.

In this context, it is advantageous if the angle between the water jet of the water jet nozzles and the perpendicular to the surface of the fibrous web is between 50° and 80°, preferably between 60° and 70°. It is advantageous if all the water jet nozzles are inclined in the opposite direction to the web running direction.

An inclination transversely with respect to the web running direction may also be advantageous with the view to preserving a separated strip from the spray water which bounces off the fibrous web or the supporting surface.

To enhance the possible uses and to vary the action on the fibrous web, different water pressures should be present at at least two water jet nozzles.

In general, it ought to be sufficient for there to be two water jet nozzles. However, for particularly thick or strong fibrous webs, it is advantageous to use at least three water jet nozzles, in which case different nozzles shapes can also be used here.

Depending on their specific function or design requirements, the water jet nozzles may be arranged precisely behind one another in the web running direction or slightly offset with respect to one another transversely to the web running direction.

To allow a sufficient time for the cut surface to soften to be ensured, the distance between two adjacent water jet nozzles should be at least 25 mm.

To achieve a satisfactory quality of cut, it is necessary for the water pressure which is present at the water jet nozzles to be between 400 and 1500 bar, preferably between 800 and 1500 bar.

To make as accurate a cut as possible, it is also advantageous if the nozzle diameter of the water jet nozzles is between 0.1 and 0.3 mm, preferably between 0.1 and 0.2.

The invention is to be explained in more detail below on the basis of two exemplary embodiments. In the appended drawing:

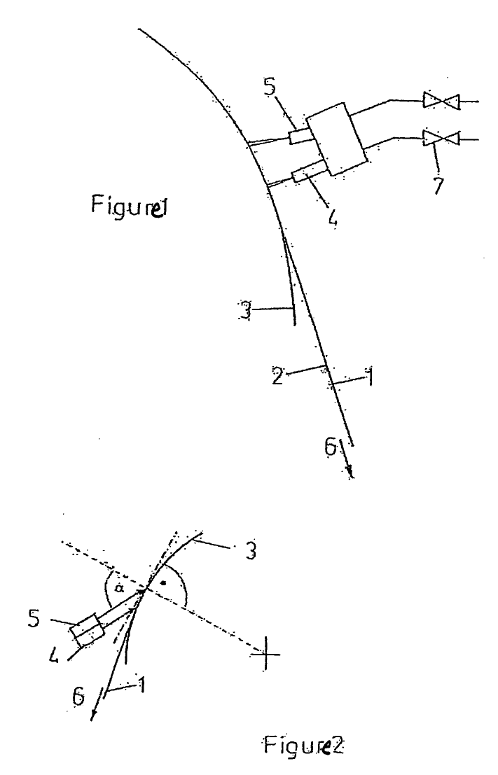

FIG. 1 diagrammatically depicts a water jet cutting device, and

FIG. 2 shows a different arrangement.

During cutting, the fibrous web 1 shown in FIG. 1 is supported by an endless revolving belt 2 in the form of a dryer fabric of a drying assembly for drying the fibrous web 1, while the belt 2 is wrapped around a rotating roll 3 in the form of a guide roll.

To transfer the fibrous web 1 when the machine is started up, it is necessary to detach a transfer strip. This transfer strip can easily be transferred into the following unit of the machine. Only thereafter is the transfer strip widened to the full width of the fibrous web 1.

The fibrous web 1 is cut using a water jet cutting device which has two water jet nozzles 4, 5 arranged behind one another in the web running direction 6. The water pressure of the two water jet nozzles 4, 5 can be set separately by means of in each case a valve 7, in the range between 1000 and 1500 bar. The nozzle diameter of the water jet nozzles 4, 5 is approx. 0.2 mm.

To enable sufficient softening of the cut region following the first water jet to be ensured even at velocities of more than 2000 m/min, the distance between the water jet nozzles 4, 5 is approximately 25 mm.

To ensure that the strength of the transfer strip is not impaired by spray water rebounding from the cut region, both water jet nozzles 4, 5 are directed away from the transfer strip transversely with respect to the web running direction 6.

Moreover, the first water jet 5 is inclined in the opposite direction to the web running direction 6, which assists with the softening of the cut surface.

On account of the fact that the first water jet nozzle 5 is at a greater distance from the fibrous web 1, the sprayed surface area of the impinging water jet is also larger than that of the following water jet. An a real jet nozzle is particularly suitable for use as first water jet nozzle 5.

In order not to weaken the transfer strip through softening in the cut region, the center of the region where the water jet from the first water jet nozzle 5 strikes the web is offset from the center of the region where the subsequent water jet strikes it by approximately 1 mm transversely with respect to the web running direction 6 away from the transfer strip.

The water pressures may also be set differently depending on the nature and condition of the fibrous web 1.

FIG. 2 shows the possibility of cutting the fibrous web 1 supported directly on a rotating roll 3. This can be used in particular for rotating rolls 3 in the form of heated drying cylinders in drying sections of papermaking machines.

In this case, both water jet nozzles 4, 5 are inclined in the opposite direction to the web running direction 6, with the angle a between the water jets and the perpendicular to the surface of the fibrous web 1 being between 600 and 700.

In addition to relieving the load on the roll 3 from the water pressure, this inclination also improves the efficiency of the cutting device, so that lower water pressures than usual are sufficient.

1. A water jet cutting device for cutting a moving web of paper, board, tissue or other fibrous material (1) in a machine for producing and/or finishing the same, comprising at least two water jet nozzles (4,5) which are arranged approximately behind one another in the web running direction (6) and are directed onto the fibrous web (1), the fibrous web (1), during the cutting operation, being supported on a rotating roller (3) or on an endlessly revolving belt (2), characterized in that at least two water jet nozzles (4,5) have nozzle diameters of different sizes and/or are at different distances from the fibrous web (1) and/or have different inclinations with respect to the surface of the fibrous web (1).

2. The water jet cutting device as claimed in claim 1, characterized in that different water pressures are present at least at two water jet nozzles (4,5).

3. The water jet cutting device as claimed in claim 1, characterized in that there are two water jet nozzles (4,5).

4. The water jet cutting device as claimed in claim 1, characterized in that there are at least three water jet nozzles (4,5).

5. The water jet cutting device as claimed in one claim 1, characterized in that the water jet nozzles (4,5) are arranged accurately behind one another in the web running direction (6).

6. The water jet cutting device as claimed in claim 1, characterized in that the water jet nozzles (4,5) are arranged behind one another in the web running direction (6) and slightly offset with respect to one another transversely to the web running direction (6).

7. The water jet cutting device as claimed in one claim 1, characterized in that the distance between two adjacent water jet nozzles (4,5) is at least 25 mm.

8. The water jet cutting device as claimed in claim 1, characterized in that the water pressure which is present at the water jet nozzles (4,5) is between 400 and 1500 bar, preferably between 800 and 1500 bar.

9. The water jet cutting device as claimed in 1, characterized in that the nozzle diameter of the water jet nozzles (4,5) is between 0.1 and 0.3 mm, preferably between 0.1 and 0.2.

10. The water jet cutting device as claimed in one claim 1, characterized in that at least one water jet nozzle (4,5) is inclined with respect to the surface of the fibrous web (1) in the opposite direction to the web running direction (6).

11. The water jet cutting device as claimed in claim 10, characterized in that the angle (α) between the water jet of the water jet nozzles (4,5) and the perpendicular to the surface of the fibrous web (1) is between 50° and 80°, preferably between 600 and 700.

12. The water jet cutting device as claimed in claim 10, characterized in that all the water jet nozzles (4,5) are inclined in the opposite direction to the web running direction (6).
